(19) United States
(12) Patent Application Publication
(10) Pub. No.: US 2011/0227385 A1
(43) Pub. Date: Sep. 22, 2011

(54) FOLDING SEAT SYSTEM

(75) Inventor: Brian S. Holder, Livonia, MI (US)

(73) Assignee: Johnson Controls Technology Company

(21) Appl. No.: 13/121,668

(22) PCT Filed: Sep. 28, 2009
(86) PCT No.: PCT/US2009/058560

§ 371 Date: Jun. 7, 2011

Related U.S. Application Data
(60) Provisional application No. 61/101,541, filed on Sep. 30, 2008.

(51) Int. Cl. B60N 2/20

(52) U.S. Cl. 297/337; 296/65.16

(57) ABSTRACT

A split stowing seat system is used, in a vehicle. The seat system may comprise a seat cushion (102) configured to be pivotally coupled about a first rotational axis (110) to a first portion of a vehicle body of the vehicle,—and a seat back (104) configured to be pivotally coupled about a second rotational axis (112) to a second portion of the vehicle body. The seat back (102) is detachably coupled to the seat cushion (104). One of the first and second rotational axes (110,112) runs along a substantially transverse direction of the vehicle and the other of the first and second rotational axes runs along a substantially perpendicular direction to the transverse direction.

### CROSS REFERENCE TO RELATED APPLICATIONS

The present invention claims priority to U.S. Provisional Patent Application No. 61/101,541 titled “Folding Seat System” and filed on Sep. 30, 2008, which is incorporated herein by reference in its entirety.

### BACKGROUND

The present disclosure relates generally to the field of seating for vehicles. More specifically, this disclosure relates to a stowable seat system that has independently displacing seat portions.

The competitive field of motor vehicles demands ever increasing innovation as a means of differentiation. One general area of increased emphasis for innovation has been within the interior of vehicles, as the owner interfaces mainly with the interior, and has led to a demand for innovation in the area of specific interior systems (e.g., seat systems, instrument panels).

It is known to construct a seat system where the seat back may fold on top of the seat cushion to reduce the package space of the seat system and to provide a clean load floor for increased utility in the form of increased storage volume. It is also known to take a folded seat system and then displace it as a unit, so that it occupies a different space to further improve the storage volume. There are several disadvantages to this method of constructing a seat system, some of which are as follows. First, because storing a seat system as one unit requires a large volume, if the seat system is going to be displaced into a compartment, the compartment must be large. It is difficult to configure a vehicle to be able to accommodate such large compartments, as conservation of space is a high priority factor in the design of vehicles. Second, additional options, such as not including the feature or offering the feature at a compromised utility, become undesirable. A compromised utility may include using a compartment that is too shallow for the whole seat system, which means that only a portion of the seat system fits within the compartment, leading to a reduced volume of utility (i.e., a less efficient system). Third, it can be difficult to displace a typical seat system as one unit due to the high mass and unstable geometry.

There is a continued need to provide a seat system with reduced mass and easier operability by synergistically utilizing other interior vehicle components. A reduced mass and reduced volume seat system can be configured to be easier for the consumer to manipulate and handle during the process of placing it into its utility position. A reduced volume seat system would also allow for more vehicles and smaller vehicles to provide increased storage volume.

### SUMMARY

According to one embodiment of the present invention, a split stowing seat system for a vehicle may comprise: a seat cushion configured to be pivotally coupled about a first rotational axis to a first portion of a vehicle body of the vehicle; and a seat back configured to be pivotally coupled about a second rotational axis to a second portion of the vehicle body. The seat back is detachably coupled to the seat cushion. One of the first and second rotational axes runs along a substantially transverse direction of the vehicle and the other of the first and second rotational axes runs along a substantially perpendicular direction to the transverse direction.

According to another embodiment of the present invention, a split stowing seat system of a vehicle may comprise: a seat back pivotally coupled to at least one of a floor and a first portion of a side wall of the vehicle; and a seat cushion pivotally coupled to at least one of a roof and a second portion of the side wall of the vehicle. The seat back is detachably coupled to the seat cushion.

It is to be understood that both the foregoing general description and the following detailed description are exemplary and explanatory only, and are not restrictive of the invention as claimed.

### BRIEF DESCRIPTION OF THE DRAWINGS

FIG. 1 is a perspective view of an embodiment of the present invention in a motor vehicle.

FIG. 2 is a perspective view of a seat system according to an embodiment of the present invention for use within a motor vehicle, such as the motor vehicle of FIG. 1.

FIG. 3 is a perspective view of the seat system shown in FIG. 2, with the seat back folded forward and proximate to the side wall of the vehicle.

FIG. 4 is a perspective view of the seat system shown in FIG. 2, with the seat cushion folded into a storage compartment of the vehicle.

FIG. 5 is a perspective view of the seat system according to another embodiment of the present invention with the seat cushion folded forward.

FIG. 6 is a perspective view of the seat system according to another embodiment of the present invention, with the seat back folded rearward and proximate to the side wall of the vehicle.

FIG. 7 is a perspective view of a seat system according to another embodiment of the present invention for use within a motor vehicle, such as the motor vehicle of FIG. 1.

FIG. 8 is a perspective view of the seat system shown in FIG. 7, with the seat cushion folded proximate to the side wall of the vehicle.

FIG. 9 is a perspective view of the seat system shown in FIG. 7, with the seat back folded forward into a storage compartment of the vehicle.

FIG. 10 is a perspective view of a seat system according to another embodiment of the present invention for use within a motor vehicle, such as the motor vehicle of FIG. 1.

FIG. 11 is a perspective view of the seat system shown in FIG. 10, with the seat back folded proximate to the roof-liner (i.e., head-liner) of a vehicle.

FIG. 12 is a perspective view of the exemplary seat system shown in FIG. 10, with the seat cushion folded proximate to the side wall of a vehicle.

FIG. 13 is a perspective view of a seat system according to another embodiment of the present invention, with the seat cushion folded rearward into a storage compartment of a vehicle.

### DETAILED DESCRIPTION

Referring generally to the FIGURES, split stowing seat systems are disclosed for use within a motor vehicle. Based on the present disclosure, a split stowing seat system can be configured to achieve, for example, optimized utility with easier functionality, which allows for increased proliferation of the use of the seat system into more and smaller vehicles.

According to one embodiment, a split stowing seat system may include a seat cushion, pivotally coupled, for example, to the floor pan of a vehicle; and a seat back, pivotally coupled, for example, to the side of a vehicle and detachably coupled to the seat cushion. The seat back may rotate about into a position proximate to the side of the vehicle and substantially parallel to the longitudinal axis of the vehicle, and the seat cushion may rotate into a storage compartment within the vehicle floor pan. This function may create a uniform load floor between vehicle and seat system with increased volume capacity for storage or other utility. According to other embodiments, the seat cushion may be pivotally coupled to the floor of the vehicle and may rotate forward into either a storage compartment or until it contacts another vehicle component, such as the seat back of a seat system located forward of it.

According to another embodiment, a split stowing seat system may include a seat cushion, pivotally coupled, for example, to the side of a vehicle; and a seat back, pivotally coupled, for example, to the floor of a vehicle. The seat cushion may rotate into a position proximate to the side of the vehicle and substantially parallel to the longitudinal axis of the vehicle, and the seat back may rotate forward into a storage compartment within the vehicle floor pan. This function may create a uniform load floor between vehicle and seat system with increased volume capacity for storage or other utility. According to another embodiment, the seat back may rotate rearward into a storage compartment within the vehicle floor pan.

According to another embodiment, a split stowing seat system may include a seat back, pivotally coupled, for example, to the side of a vehicle; and a seat cushion, pivotally coupled, for example, to the side of a vehicle. The seat back may rotate upwards into a position substantially parallel to the roof of the vehicle, and the seat cushion may rotate into a position proximate and substantially parallel to the longitudinal axis of the vehicle. This function may create a uniform load floor in the vehicle with increased volume capacity for storage or other utility, since the seat system is displaced out of the space used for utility. According to other embodiments, the seat cushion may be pivotally coupled to the floor of the vehicle and may rotate forward or rearward into a storage compartment or against another seat system or vehicle component. Additionally, the seat back may be pivotally coupled to the roof of the vehicle.

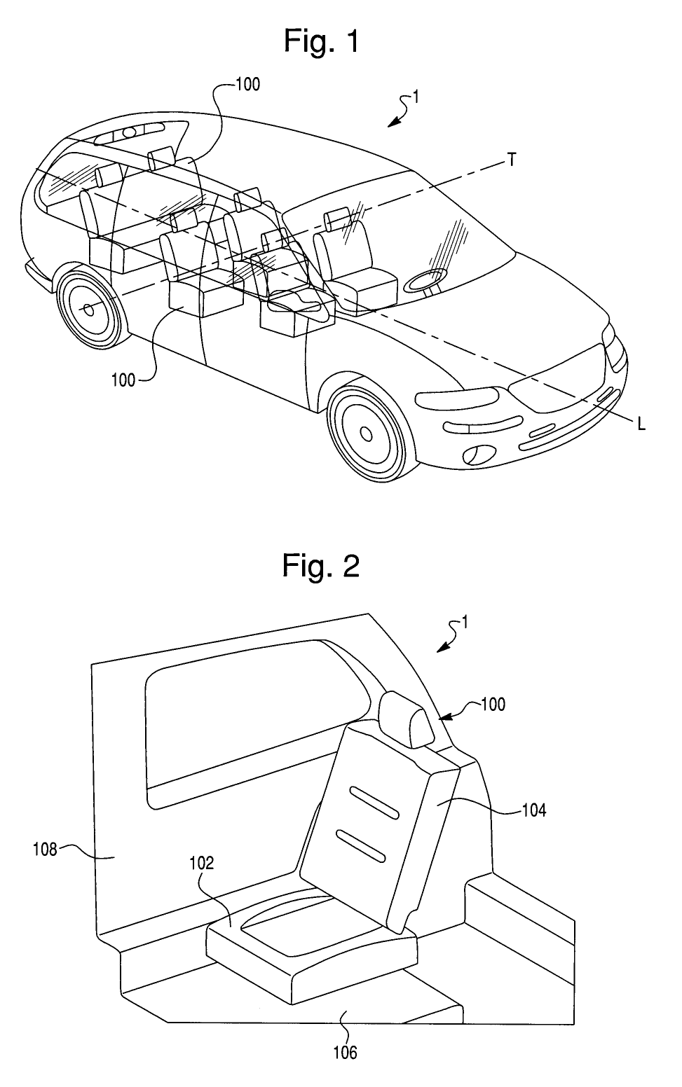

Referring to FIG. 1, a vehicle 1 is shown according to an exemplary embodiment. The vehicle 1 may include one or more seat systems 100 provided for occupant(s) of the vehicle 1. While the vehicle 1 illustrated is a van, it should be noted that the disclosed seat system may be used within a sedan, sport utility vehicle, airplane, boat, or any other vehicle. The transverse direction T of the vehicle shown in FIG. 1 is the cross-car (or side-to-side) direction of the vehicle while the longitudinal direction L of the vehicle runs in the front-to-rear direction of the vehicle.

Referring to FIGS. 2 thru 4, a split stowing seat system 100 for use within a vehicle 1 is shown according to an exemplary embodiment. The seat system 100 may include a seat cushion 102 and a seat back 104. The seat cushion 102 may be configured to be pivotally coupled about a first rotational axis 110 (a seat cushion rotational axis) to a first portion of the vehicle body of the vehicle, such as the floor or the floor pan 106. The seat back 104 may be configured to be pivotally coupled about a second rotational axis 112 (a seat back rotational axis) to a second portion of the vehicle body, such as the side wall 108 (for example, a quarter trim) of the vehicle 1. The seat back 104 can be detachably coupled to the seat cushion 102.

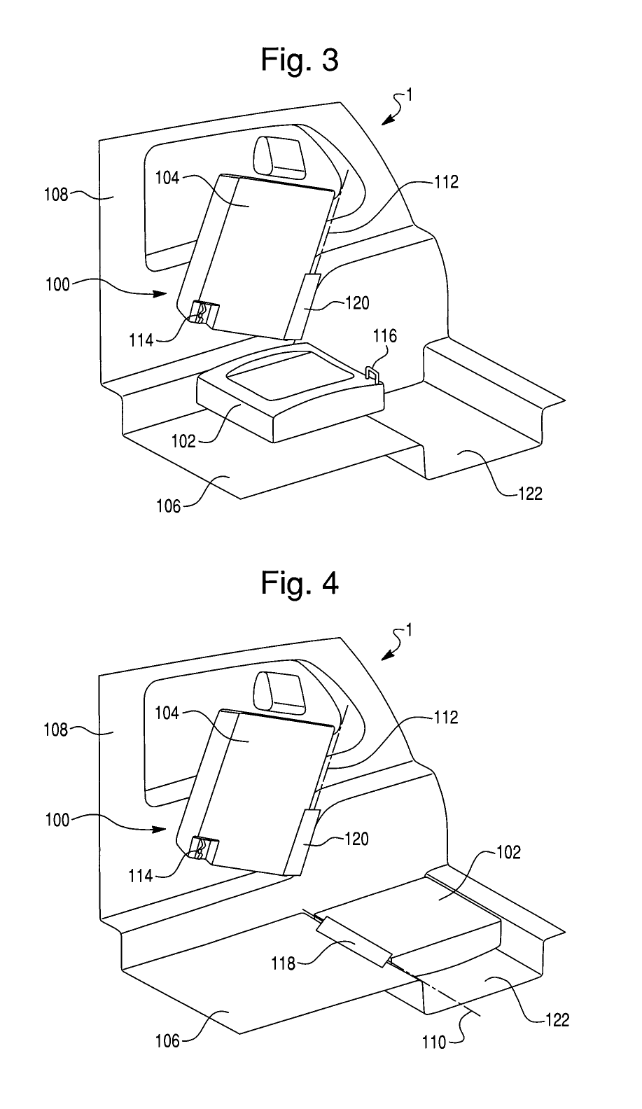

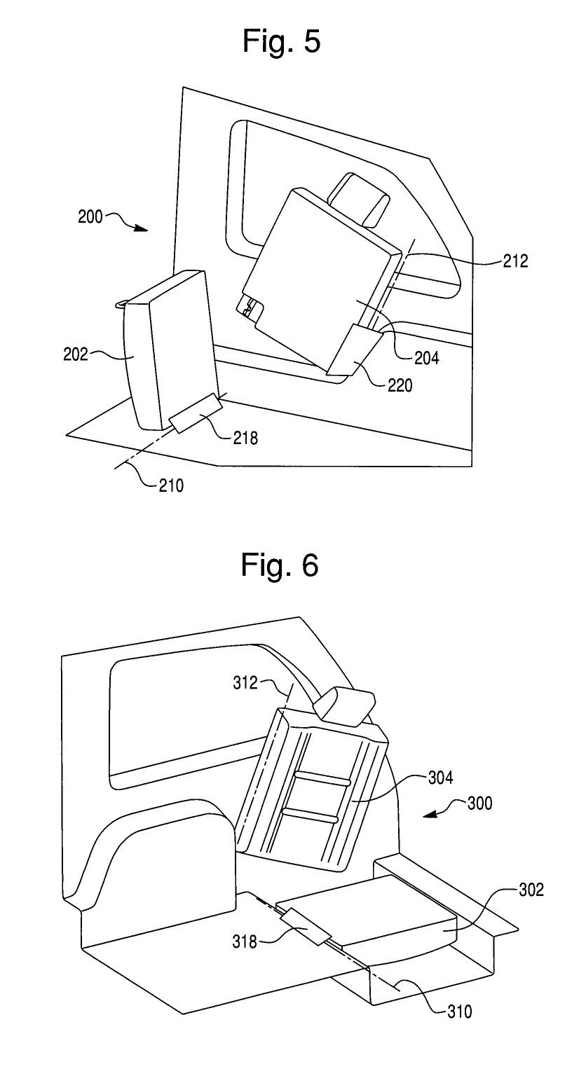

The seat back 104 may include a foam pad, a trim cover, a structure, and at least one mechanism 120 (schematically shown in FIGS. 3-4) that allows the seat back 104 to rotate about the first rotational axis 110. Optionally, the seat back 104 may have at least cushion locking mechanism 114 to lock the seat back 104 to the seat cushion 102 in the seating position and at least one release member (not shown). The construction of the trim covers, foam pads and structures can be done according to conventional methods.

The seat cushion 102 may include a foam pad, a trim cover, a structure, and at least one mechanism 118 (schematically shown in FIG. 4) that allows the seat cushion 102 to rotate about the second rotational axis 112. Optionally, the seat cushion may have at least one seat back attachment mechanism 116 that works in conjunction with the cushion locking mechanism 114 to lock the seat back with the seat cushion, and at least one release member (not shown). The construction of the trim covers, foam pads and structures can be done according to conventional methods.

The cushion rotation mechanism 118 may lock the seat cushion 102 in at least one or two positions (e.g., seating position, stow position) and may be constructed from conventional methods (e.g., pawl and sector, cam and pawl, rotary) or may be constructed to accommodate specific vehicle requirements using any method. Also, the seat back rotation mechanism 120 may lock the seat back 104 in at least one or more positions (e.g., seating position, stow position) and may be constructed from conventional methods (e.g., pawl and sector, cam and pawl, rotary, other forms of lockable hinges) or may be constructed to accommodate specific vehicle requirements using any method. Alternatively or additionally, the cushion locking mechanism 114 may lock to the seat back attachment mechanism 116 on the seat back 104 to lock the seat back 104 to the cushion 102 in the seating position and may be constructed using conventional methods (e.g., cam and hook) or may be constructed to accommodate specific vehicle requirements using any method. For example, the seat back attachment mechanism 116 may be a U-bar and the cushion locking mechanism 114 may be a releasable latch that grips the U-bar. According to other embodiments of split stowing seat systems 100, the seat back rotation mechanism 120 may be configured to lock only in the seating position and the seat cushion rotation mechanism 118 may be configured to lock only in the seating position.

FIG. 2 shows the split stowing seat system 100 for use within the vehicle 1 wherein the seat system 100 may include the seat cushion 102 pivotally coupled to the floor pan 106 of the vehicle 1 at a first portion of the vehicle body, and the seat back 104 pivotally coupled to the side wall (quarter trim) 108 of the vehicle 1 at a second portion of the vehicle body. Both the seat cushion 102 and the seat back 104 are in the seating position. The seat cushion 102 may lock according to an exemplary embodiment or it may have a hard stop for this forward position according to another embodiment. The seat back 104 may be locked to the vehicle 1 via the seat back rotation mechanism 120 and to the cushion 102 via the cushion locking mechanism 114 and seat back attachment mechanism 116 or it may be locked to the vehicle 1 only.

Referring to FIG. 3, the seat system 100 of FIG. 2 is illustrated with the seat back 104 rotated proximate to the side wall 108 (quarter trim) of the vehicle 1 by rotation about the seat back rotational axis 112. The rotational axis 112 runs along a perpendicular direction of the transverse direction or a substantially perpendicular direction of the transverse direction of the vehicle, in which substantially perpendicular may mean within 1, 2, 5, 10, 15, 20, or 25 degrees from the perpendicular direction of the transverse direction. The inner vertical edge of the seat back 104 preferably is rotated about the seat back rotational axis so as to be in front of the outer vertical edge in the longitudinal direction of the vehicle.

Actuation of the seat back release member may unlock the seat back rotation mechanism 120 such that the seat back 104 is free to rotate about the seat back rotational axis 112 to its stow position. The seat back release member may also be configured to unlock the cushion locking mechanism 114, such that the seat back 104 is decoupled from the seat cushion 102, to allow free rotation of the seat back 104 to the stow position. The seat back mechanism(s) once unlocked by the release member allows the seat back 104 to be rotated about the seat back rotational axis 112 to its stow position, wherein the seat back width may be substantially parallel to the side wall 108 of the vehicle 1 and the seat back A-surface (meaning its seating surface or front surface) may rest adjacent or substantially proximate to the side wall 108 (such as the quarter trim) of the vehicle 1. The seat back rotation mechanism 120 may be configured to lock the seat back 104 in the stow position or may be constructed to have another method (e.g., hard stop, spring, detent) to retain it in its stow position. The seat back rotation may be configured to rotate freely and may be limited by contact with a vehicle component (e.g., the side wall or quarter trim).

Referring to FIG. 4, the seat system 100 of FIG. 2 is illustrated in its stow position, with its seat back 104 rotated about the seat back rotational axis 112 so as to have its A-surface proximate to the side wall 108 of the vehicle 1, and with its seat cushion 102 rotated about the seat cushion rotational axis 110 into a seat cushion storage compartment 122 of the floor pan 106 of the vehicle 1. Actuation of the seat cushion release member may unlock the seat cushion rotation mechanism 118 such that the seat cushion 102 is free to rotate rearward about the rotational axis 110 to its stow position, wherein the seat cushion length may be substantially parallel to the longitudinal axis of the vehicle 1 and the seat cushion A-surface (meaning its seating surface) may rest adjacent or substantially proximate to the vehicle floor pan 106. The rotational axis 110 may run along a transverse (or cross-car) direction of the vehicle or a substantially transverse direction of the vehicle in which substantially transverse direction may mean within 1, 2, 5, 10, 15, 20, or 25 degrees of the transverse direction of vehicle. The seat cushion 102 in its stow position may be configured such that its B-surface (the non-seating surface on the bottom of the seat) is substantially parallel to and even with (relative to height) the load floor of the vehicle 1. The seat cushion storage compartment 122 may be located in front of or in back of the seat cushion 102. Thus, according to one embodiment, the seat cushion is configured to rotate about the seat cushion rotational axis 110 into the storage compartment 122 within the vehicle floor pan 106 in a rearward direction such that the front edge of the seat cushion rotates about the rear edge of the seat cushion, such as shown in FIGS. 3-4. According to another embodiment, the seat cushion is configured to rotate about the seat cushion rotational axis into the storage compartment within the vehicle floor pan in a forward direction such that the rear edge of the seat cushion rotates about the front edge of the seat cushion in the storage compartment. The stow position of the seat cushion would then be substantially parallel to the longitudinal axis of the vehicle 1 in which the seat cushion A-surface may rest proximate to the floor pan 106 of the vehicle 1 and the B-surface of the seat cushion 102 may be substantially parallel to and even with (relative to height) the load floor of the vehicle 1. To accomplish this, the depth of the storage compartment may be the same distance as (or larger than) the thickness of the seat component that fits inside it when in its stowed position. For example, if the seat cushion is to be stowed in the storage compartment, the depth of the storage compartment may be the same distance or have a greater distance than the thickness of the seat cushion. If the depth of the storage compartment is the same distance as the thickness of the seat cushion, then the bottom surface of the seat cushion would be flush with the load floor of the vehicle.

Referring to FIG. 5, another embodiment of the seat system 200 is illustrated. The seat back 204 may be similar to the seat back 104 of FIGS. 2-4 in which the seat back 204 may be rotated adjacent or substantially proximate to the side wall 108 (quarter trim) of the vehicle 1 by rotation about a seat back rotational axis 212. The rotational axis 212 runs along a perpendicular direction of the transverse direction or along a substantially perpendicular direction of the transverse direction of the vehicle. Actuation of the seat back release member may unlock the seat back rotation mechanism 220 such that the seat back 104 is free to rotate about the seat back rotational axis 212 to its stow position. The seat cushion 202 may rotate forward about the seat cushion rotational axis 210 that runs along a transverse or substantially transverse direction of the vehicle to its stow position. The seat cushion 102 may contact a forward positioned seat system or another vehicle component which limits the rotation of the seat cushion 102. The cushion rotation mechanism 218 may lock the seat cushion 202 in at least one or two positions (e.g., seating position, stow position) and may be constructed from conventional methods (e.g., pawl and sector, cam and pawl, rotary).

Referring to FIG. 6, another embodiment of the seat system 300 is illustrated. The seat back 304 may rotate rearward about a seat back rotational axis 312 wherein the seat back width may be substantially parallel to the side of the vehicle 1 and the seat back B-surface (meaning its non-seating surface or back surface) may rest adjacent or substantially proximate to the side wall or quarter trim of the vehicle 1. The inner vertical edge of the seat back 104 is rotated about the seat back rotational axis so as to be behind the outer vertical edge in the longitudinal direction of the vehicle. The rotational axis 312 runs along a perpendicular direction of the transverse direction or along a substantially perpendicular direction of the transverse direction of the vehicle. The seat cushion 302 could rotate rearward about the seat cushion rotational axis 310 as shown in FIG. 6 in which seat cushion rotational axis 310 runs in a transverse or substantially transverse direction in a manner similar to that disclosed for the embodiment of FIGS. 2-4. The cushion rotation mechanism 318 may lock the seat cushion 302 in at least one or two positions (e.g., seating position, stow position) and may be constructed from conventional methods (e.g., pawl and sector, cam and pawl, rotary).

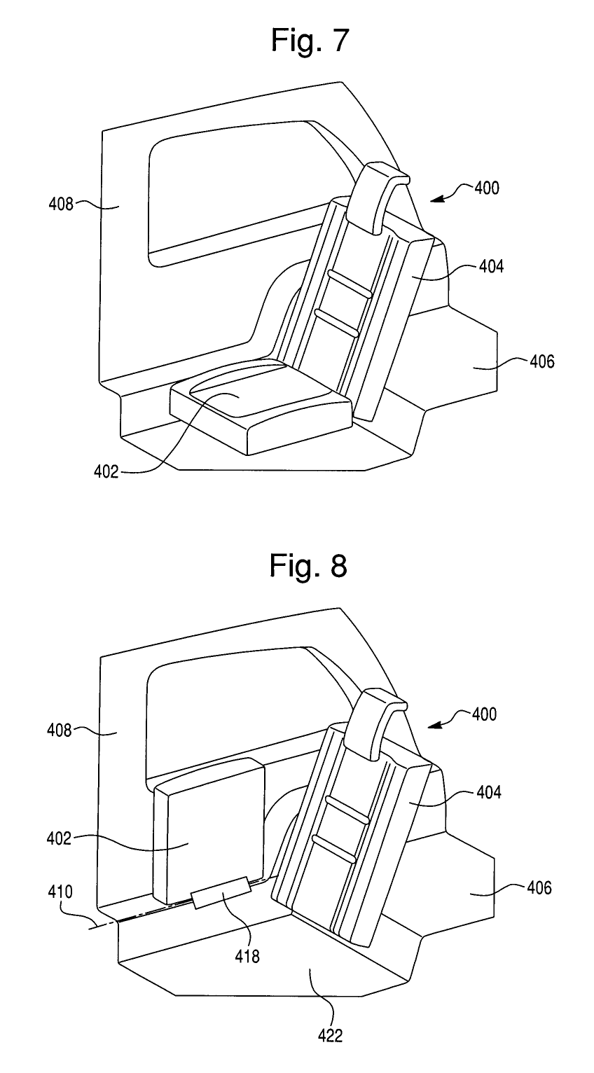

Referring to FIGS. 7 thru 9, a split stowing seat system 400 for use within a vehicle is shown according to another exemplary embodiment. The seat system 400 may include a seat back 404 pivotally coupled about a second rotational axis 412 to a second portion of the vehicle body, such as the floor or the floor pan 406 of the vehicle; and a seat cushion 102 pivotally coupled about a first rotational axis 410 to a first portion of the vehicle body, such as the side wall 408 of the vehicle. The seat back 104 may include a foam pad, a trim cover, a structure, at least one mechanism 420 to rotate the seat back 104 about the seat back rotational axis 412, and at least one release member. The seat cushion 102 may include a foam pad, a trim cover, a structure, at least one mechanism 418 to rotate the seat cushion 102 about the seat cushion rotational axis 410, and at least one release member. The construction of the trim covers, foam pads and structures can be done according to conventional methods. The seat back rotation mechanism 420 may lock the seat back 104 in at least one position or two positions (e.g., seating position, stow position) and may be constructed from conventional methods (e.g., pawl and sector, cam and pawl, rotary) or may be constructed to accommodate specific vehicle requirements using any method. The cushion rotation mechanism 418 may lock the seat cushion 402 in at least one position or two positions (e.g., seating position, stow position) and may be constructed from conventional methods (e.g., pawl and sector, cam and pawl, rotary) or may be constructed to accommodate specific vehicle requirements using any method.

FIG. 7 illustrates the split stowing seat system 400 in the seating position, wherein the seat cushion rotation mechanism 418 may lock according to an exemplary embodiment or it may have a hard stop for this forward position according to another embodiment. Additionally, the seat back 404 may be locked to prevent its rotation relative to the vehicle (and to the cushion 402). According to other embodiments of split stowing seat systems, the seat back rotation mechanism 420 may be configured to lock only in the seating position and the seat cushion rotation mechanism 418 may be configured to lock only in the seating position or only in the stow position.

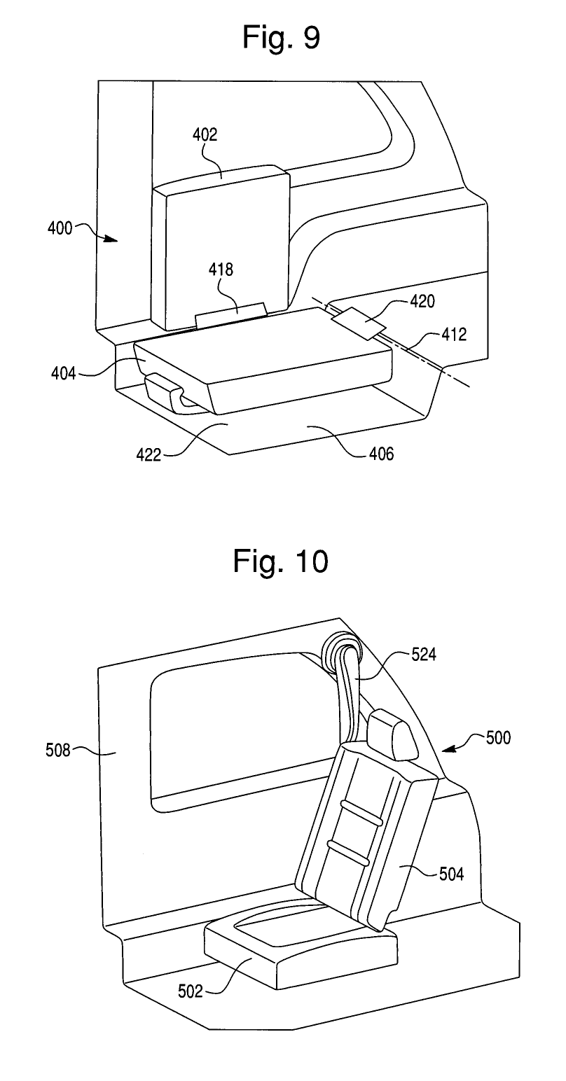

Referring to FIG. 8, the seat system 400 of FIG. 7 is illustrated with the seat cushion 402 rotated proximate to the side wall 408 (such as the quarter trim) of the vehicle. Actuation of the seat cushion release member may unlock the seat cushion rotation mechanism 418 such that the seat cushion 402 is free to rotate about its rotational axis 410 to its stow position, wherein the seat cushion length may be substantially parallel to the longitudinal axis of the vehicle and the seat cushion A-surface may rest adjacent or substantially proximate to the side wall 408 (e.g., the quarter trim) of the vehicle. The rotational axis 410 runs along a perpendicular direction to the transverse direction of the vehicle or along a substantially perpendicular direction to the transverse direction of the vehicle. The rotation of the seat cushion is characterized in that, for the two edges of the seat cushion that run along the longitudinal direction of the vehicle, the inner longitudinal edge is lifted up so as to be above the outer longitudinal edge. The seat cushion rotation mechanism 418 may be configured to lock the seat back 404 in the stow position or may be constructed to have another method (e.g., hard stop, spring, detent) to limit rotation and hold the seat cushion 402 in place. The seat cushion rotation may be configured to rotate freely and may be limited by contact with a vehicle component (e.g., quarter trim).

Referring to FIG. 9, the seat system 400 of FIG. 7 is illustrated in its stow position, with its seat cushion 402 rotated proximate to the side wall 408 of the vehicle, and with its seat back 404 rotated forward about the seat back rotational axis 412 into a seat back storage compartment 422 of the vehicle such that the top edge of the seat back moves forward and downward relative to the bottom edge of the seat back. Actuation of the seat back release member may unlock the seat back rotation mechanism 420 such that the seat back 404 is free to rotate forward about the second rotational axis 412 to its stow position, wherein the seat back length may be substantially parallel to the longitudinal axis of the vehicle and the seat back A-surface may rest adjacent or substantially proximate to the vehicle floor pan 406. The second rotational axis 412 runs along a transverse (cross-car) direction of the vehicle or along a substantially transverse direction of the vehicle. The seat back 104 in its stow position may be configured such that its B-surface is substantially parallel to and even with (relative to height) the load floor of the vehicle.

According to another embodiment of the seat system shown in FIG. 7, the seat back 404 may be rotated rearward about the seat back rotational axis 412 to its stow position, wherein the seat back 404 may be substantially parallel to the longitudinal axis of the vehicle and the seat back B-surface may rest proximate to the floor pan 406 of the vehicle. This embodiment may be configured such that the A-surface of the seat back 404 when in its stow position would be substantially parallel to and even with (relative to height) the load floor of the vehicle.

Referring to FIGS. 10 thru 12, a split stowing seat system 500 for use within a vehicle is shown according to another embodiment of the present invention. The seat system 500 may include a seat back 504 pivotally coupled about a second rotational axis 512 to a second portion of the vehicle body, such as a second section of the side wall 508 or the roof of the vehicle, by a pivot arm mechanism 524; and a seat cushion 502 pivotally coupled about a first rotational axis 510 to a first portion of a vehicle body, such as a first section of the side wall 508 of the vehicle. The first rotational axis 510 runs along a perpendicular direction to the transverse direction or substantially perpendicular direction to the transverse direction of the vehicle while the second rotational axis 512 runs along the transverse direction or substantially transverse direction of the vehicle.

The seat back 504 may include a foam pad, a trim cover, a structure, at least one mechanism to rotate the seat back 504 (in the form of the pivot arm mechanism 524), and at least one release member. The seat cushion 502 may include a foam pad, a trim cover, a structure, at least one mechanism 518 to rotate the seat cushion 502, and at least one release member. The construction of the trim covers, foam pads and structures can be done according to conventional methods.

The seat back pivot arm mechanism 524 may lock the seat back 504 in at least one or two positions (e.g., seating position, stow position) and may be constructed from conventional methods (e.g., pawl and sector, cam and pawl, rotary) or may be constructed to accommodate specific vehicle requirements using any method. The cushion rotation mechanism 518 may lock the seat cushion 502 in at least one or two positions (e.g., seating position, stow position) and may be constructed from conventional methods (e.g., pawl and sector, cam and pawl, rotary) or may be constructed to accommodate specific vehicle requirements using any method.

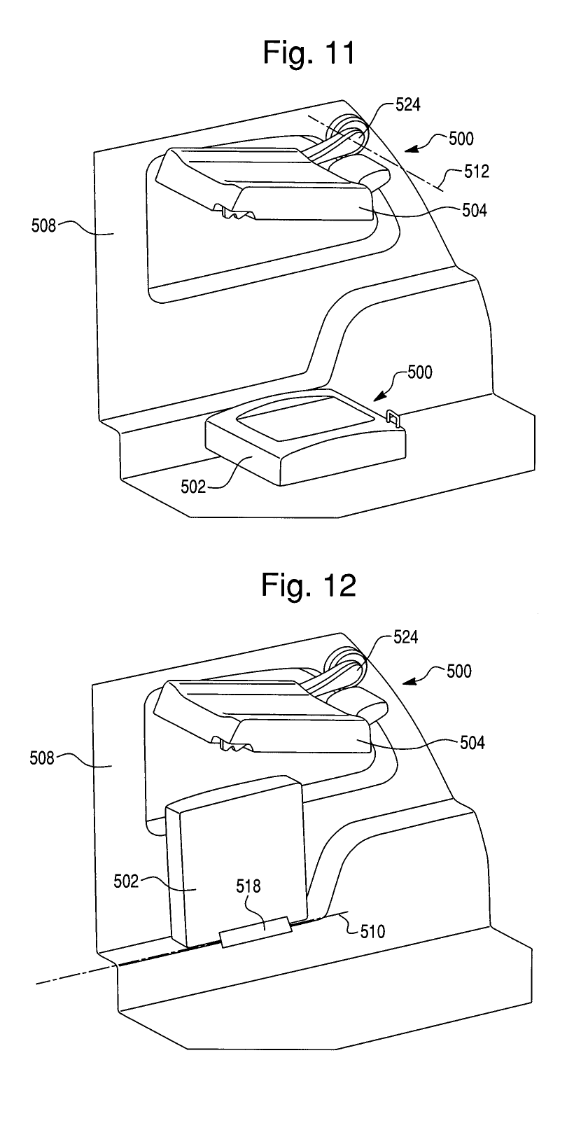

Referring to FIG. 11, the seat system 500 of FIG. 10 is illustrated with the seat back 504 rotated upwards about the second rotational axis 524 into a position proximate to the roof or roof-liner of the vehicle. Actuation of the seat back release member may unlock the seat back pivot arm mechanism 524 such that the seat back 504 is free to rotate about its rotational axis 512 to its stow position. The pivot arm mechanism 524, once unlocked by the release member, allows the seat back 504 to be rotated to its stow position, wherein the seat back length may be substantially parallel to the longitudinal axis of the vehicle and the seat cushion A-surface may rest adjacent or substantially proximate to the roof or roof-liner of the vehicle. The pivot arm mechanism 524 may be configured to lock the seat back 104 in its stow position by any known method or apparatus known in the art.

Referring to FIG. 12, the seat system 500 of FIG. 10 is illustrated in its stow position. The seat back 504 is rotated upwards about the seat back rotational axis 512 to a position proximate to and parallel or substantially parallel with the roof of the vehicle, and the seat cushion 502 is rotated about the seat cushion rotational axis 510 into a position proximate to the side wall 508 of the vehicle, wherein the seat cushion length may be substantially parallel to the longitudinal axis of the vehicle and the seat cushion A-surface may rest adjacent or substantially proximate to the side wall (e.g., the quarter trim) of the vehicle. Actuation of the seat cushion release member may unlock the seat cushion rotation mechanism 518 such that the seat cushion 102 may be free to rotate upwards about its rotational axis 510 to its stow position. The rotation of the seat cushion 502 is characterized that, for the two edges of the seat cushion that run along the longitudinal direction of the vehicle, the inner longitudinal edge is lifted up so as to be above the outer longitudinal edge.

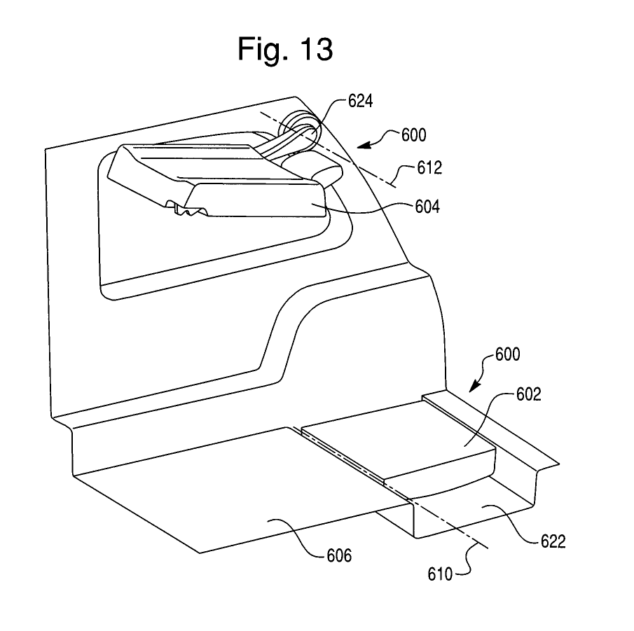

Referring to FIG. 13, a seat system 600 is illustrated according to another embodiment of the present invention in its stow position. The seat back 604 functions similarly to the seat back 504 of FIGS. 10-12. The seat back 604 is pivotally coupled about a second rotational axis to a second portion of the vehicle body, such as a second portion of the side wall 508 or the roof of the vehicle, by a pivot arm mechanism 624. The seat cushion 602 is pivotally coupled about a first rotational axis 610 to a first portion of a vehicle body, such as a second portion of the side wall 508, the floor or floor pan 606 of the vehicle. The seat back 604 is configured to rotate upwards about the seat back rotational axis 612 into a position parallel or substantially parallel to the roof of the vehicle. The seat cushion 602 is constructed or configured to be pivotally coupled to the floor, floor pan, or side wall of the vehicle and may be rotated, upon actuation of a release member, rearward into a storage compartment 622 of the vehicle. According to other embodiments, the seat back may be pivotally coupled to the roof of the vehicle, the seat cushion may rotate forward into a position contact with another forward positioned seat or vehicle component (similar to that shown for the seat cushion 202 shown in FIG. 5), or the seat cushion may be rotated forward into a storage compartment located in front of the seat cushion.

According to the embodiments disclosed, split-stowing seat systems can be configured to provide a reduced mass and easier operable seat system with optimized storage utility, by synergistically utilizing other interior vehicle components. Split-stowing seat systems can be configured to be easier for the consumer to manipulate and handle during the process of displacing it into its utility position, since the seat cushion and the seat back are independently displaced. This independent operation, reduces the mass and size that the consumer is manipulating which improves the ergonomics of operation of the seat system. Split-stowing seat systems may allow for more vehicles and smaller vehicles to incorporate the utility of a stowable seat system, since the independent displacing seat back and seat cushion require two smaller volumes, which are easier for vehicle manufacturers to provide packaging space for than one large volume.

Some of the disclosed embodiments of the present invention may permit the storage of a split stowing seat system for a vehicle through the steps of: detaching the coupling of a seat back and a seat cushion; pivoting the seat cushion about a first rotational axis of the vehicle; and pivoting the seat back about a second rotational axis of the vehicle. One of the first and second rotational axes runs along a substantially transverse direction of the vehicle and the other of the first and second rotational axes runs along a substantially perpendicular direction to the transverse direction.

Some of the disclose embodiments of the present invention may permit the storage of a split stowing seat system for a vehicle through the steps of: detaching the coupling of a seat back and a seat cushion; pivoting a seat back coupled to at least one of a floor and a first portion of a side wall of the vehicle; and pivoting a seat cushion coupled to at least one of a roof and a second portion of the side wall of the vehicle.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the seat system as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A split stowing seat system for a vehicle, comprising:
a seat cushion configured to be pivotally coupled about a first rotational axis to a first portion of a vehicle body of the vehicle; and
a seat back configured to be pivotally coupled about a second rotational axis to a second portion of the vehicle body,
wherein the seat back is detachably coupled to the seat cushion,
wherein one of the first and second rotational axes runs along a substantially transverse direction of the vehicle and the other of the first and second rotational axes runs along a substantially perpendicular direction to the transverse direction.

2. The split stowing seat system according to claim 1, wherein the first portion of the vehicle body is at least one of a floor and a floor pan of the vehicle.

3. The split stowing seat system according to claim 2, wherein the seat cushion is configured to rotate about the first rotational axis into a storage compartment within the vehicle floor pan.

4. The split stowing seat system according to claim 3, wherein the seat cushion is configured to rotate forward or rearward about the first rotational axis into the storage compartment.

5. The split stowing seat system according to claim 2, wherein the seat cushion is configured to rotate about a front edge of the seat cushion until the seat cushion contacts a vehicle component seat located in front of the seat system.

6. The split stowing seat system according to claim 1, wherein the second portion of the vehicle body is a side wall of the vehicle.

7. The split stowing seat system according to claim 6, wherein the seat back is configured to rotate about the second rotational axis into a position proximate to the side wall of the vehicle.

8. The split stowing seat system according to claim 1, wherein the first portion of the vehicle body is a side wall of the vehicle.

9. The split stowing seat system according to claim 8, wherein the seat cushion is configured to rotate along the first rotational axis into a position proximate to the side wall of the vehicle.

10. The split stowing seat system according to claim 1, wherein the second portion of the vehicle body is a floor of the vehicle.

11. The split stowing seat system according to claim 10, wherein the seat back is configured to rotate along the second rotational axis into a storage compartment within a vehicle floor pan.

12. The split stowing seat system according to claim 11, wherein the seat back is configured to rotate rearward or forward about the second rotational axis into the storage compartment.

13. The split stowing seat system according to claim 1, wherein the first portion of the vehicle body is a first section of a side wall of the vehicle and the second portion of the vehicle body is a second section of the side wall of the vehicle.

14. The split stowing seat system according to claim 13, wherein the seat back is configured to rotate upwards about the second rotational axis into a position proximate to and substantially parallel with a roof of the vehicle.

15. The split stowing seat system according to claim 13, wherein the seat cushion is configured to rotate about the first rotational axis into a position proximate to the side wall of the vehicle.

16. A split stowing seat system of a vehicle comprising:
a seat back pivotally coupled to at least one of a floor and a first portion of a side wall of the vehicle; and
a seat cushion pivotally coupled to at least one of a roof and a second portion of the side wall of the vehicle,
wherein the seat back is detachably coupled to the seat cushion.

17. The split stowing seat system according to claim 16, wherein the seat back is configured to rotate upwards into a position substantially parallel to the roof of the vehicle.

18. The split stowing seat system according to claim 16, wherein the seat cushion is configured to rotate into a position proximate to the side wall of the vehicle.

19. The split stowing seat system according to claim 16, wherein the seat cushion is configured to be pivotally coupled to the floor of the vehicle and to be rotated forward or rearward into a storage compartment.

20. The split stowing seat system according to claim 16, wherein the seat back is configured to be pivotally coupled to the roof of the vehicle.
